(19) United States
(12) Patent Application Publication
(10) Pub. No.: US 2020/0104246 A1
(43) Pub. Date: Apr. 2, 2020

(54) CONTINUOUS AUTOMATION WITH TEST SUITE ENGINE

(71) Applicant: CA, Inc., Islandia, NY (US)

(72) Inventor: Bhuvan Bhatt, Hyderabad (IN)

(73) Assignee: CA, Inc., Islandia, NY (US)

(21) Appl. No.: 16/149,028

(22) Filed: Oct. 1, 2018

(51) Int. Cl. G06F 11/36

(52) U.S. Cl. CPC G06F 11/3688; G06F 11/368; G06F 11/3684; G06F 11/3692

(57) ABSTRACT

A system can include a hardware processor and a memory communicably coupled to the hardware processor, the memory for storing data. The hardware processor is to identify, by a testing engine, a function call in computer code; identify, from an identifier of the function call, a test case stored in the memory and mapped to the function call, the test case comprising one or more testing scenarios to test the function call; test the computer code using the test case; and provide a report identifying a result of the testing of the computer code.

### BACKGROUND

Continuous integration and delivery models are used for constructing enterprise applications by multiple developers working on copies of shared mainline. Such models use a high number of integration tests involving running a complete integration and delivery suite. Running full integration and delivery suites for each iteration or modification of code functions or subfunctions can increase deployment latency, and can use a large amount of system resources.

### SUMMARY

Aspects of the embodiments are directed to non-transitory computer-readable medium having program instructions stored therein, wherein the program instructions are executable by a computer system to perform operations that include identifying, by a test suite engine of a continuous integration system, a function call in computer code; identifying, from an identifier of the function call, a test suite to test the function call, the test suite comprising a subset of test cases corresponding to the function call; testing the computer code using subset of test cases comprised in the test suite; and providing a report identifying a result of the testing of the computer code.

In some embodiments, the computer code can include a plurality of function calls, the operations further comprising identifying, from an identifier of each of the plurality of function calls, a test case mapped to each of the plurality of function calls; and testing the computer code using the test case mapped to each of the plurality of function calls.

In some embodiments, the operations can also include performing an integration test on the computer code; identifying the function call from the full integration test; determining one or more testing scenarios used in the integration test to test the function call; mapping the one or more testing scenarios to a test case; mapping the test case to the function call based on the identifier of the function call; and storing the test case in a repository.

In some embodiments, identifying, by the testing engine, the function call in the computer code comprises identifying the function call using a probe function.

In some embodiments, identifying, from an identifier of the function call, a test case mapped to the function call, the test case comprising one or more testing scenarios to test the function call can include determining that a test case associated with the identifier of the function call does not exist, and performing a integration test on the function call. The integration test can also include testing the function call using one or more testing scenarios, mapping the testing scenarios to a new test case, associating the new test case with the identifier of the function call, and storing the test case in a repository; and using the new test case to test the function call using the one or more mapped testing scenarios.

In some embodiments, test case is mapped to an identifier of the function call using a format that comprises the identifier of the function call and a list of the one or more testing scenarios.

In some embodiments, the function call is a first function call; the computer code is a first computer code; the one or more testing scenarios is a first set of testing scenarios; and the test case is a first test case. The operations can also include identifying the first function call in a second computer code, the second computer code comprising a plurality of second function calls; identifying a second test case for the first function call based on one or more test cases identified for the plurality of second function calls in the second computer code; and updating the mapping of the first test case to the function call with the second test case, the second test case comprising a second set of testing scenarios different from the first set of testing scenarios.

Aspects of the embodiments include computer-implemented method that includes identifying, by a testing engine, a function call in computer code; identifying, from an identifier of the function call, a test case mapped to the function call, the test case comprising one or more testing scenarios to test the function call; testing the computer code using the test case; and providing a report identifying a result of the testing of the computer code.

Some embodiments include identifying, from an identifier of each of the plurality of function calls, a test case mapped to each of the plurality of function calls; and testing the computer code using the test case mapped to each of the plurality of function calls.

Some embodiments include performing an integration test on the computer code; identifying the function call from the full integration test; determining one or more testing scenarios used in the integration test to test the function call; mapping the one or more testing scenarios to a test case; mapping the test case to the function call based on the identifier of the function call; and storing the test case in a repository.

In some embodiments, identifying, by the testing engine, the function call in the computer code comprises identifying the function call using a probe function.

In some embodiments, identifying, from an identifier of the function call, a test case mapped to the function call, the test case comprising one or more testing scenarios to test the function call including determining that a test case associated with the identifier of the function call does not exist; performing a integration test on the function call. The integration test including testing the function call using one or more testing scenarios, mapping the testing scenarios to a new test case, associating the new test case with the identifier of the function call, and storing the test case in a repository; and the method including using the new test case to test the function call using the one or more mapped testing scenarios.

In some embodiments, the test case is mapped to an identifier of the function call using a format that comprises the identifier of the function call and a list of the one or more testing scenarios.

In some embodiments, the function call is a first function call; the computer code is a first computer code; the one or more testing scenarios is a first set of testing scenarios; and the test case is a first test case. The method can include identifying the first function call in a second computer code, the second computer code comprising a plurality of second function calls; identifying a second test case for the first function call based on one or more test cases identified for the plurality of second function calls in the second computer code; and updating the mapping of the first test case to the function call with the second test case, the second test case comprising a second set of testing scenarios different from the first set of testing scenarios.

Aspects of the embodiments are directed to a system that includes a hardware processor; and a memory communicably coupled to the hardware processor, the memory for storing data. The hardware processor is to identify, by a testing engine, a function call in computer code; identify, from an identifier of the function call, a test case stored in the memory and mapped to the function call, the test case comprising one or more testing scenarios to test the function call; test the computer code using the test case; and provide a report identifying a result of the testing of the computer code.

In some embodiments, the memory comprises a remote storage accessible by the hardware processor across a network.

In some embodiments, the hardware processor is to identify, from an identifier of each of the plurality of function calls, a test case mapped to each of the plurality of function calls; and test the computer code using the test case mapped to each of the plurality of function calls.

In some embodiments, the hardware processor is to perform an integration test on the computer code; identify the function call from the full integration test; determine one or more testing scenarios used in the integration test to test the function call; map the one or more testing scenarios to a test case; map the test case to the function call based on the identifier of the function call; and store the test case in a repository.

In some embodiments, identifying, by the testing engine, the function call in the computer code comprises identifying the function call using a probe function.

In some embodiments, the hardware processor is to determine that a test case associated with the identifier of the function call does not exist; perform a integration test on the function call, the integration test comprising testing the function call using one or more testing scenarios, mapping the testing scenarios to a new test case, associating the new test case with the identifier of the function call, and storing the test case in a repository. The hardware processor is to use the new test case to test the function call using the one or more mapped testing scenarios.

In some embodiments, the hardware processor maps the test case mapped to an identifier of the function call using a format that comprises the identifier of the function call and a list of the one or more testing scenarios.

In some embodiments, the function call is a first function call; the computer code is a first computer code; the one or more testing scenarios is a first set of testing scenarios; and the test case is a first test case. The hardware processor is to identify the first function call in a second computer code, the second computer code comprising a plurality of second function calls; identify a second test case for the first function call based on one or more test cases identified for the plurality of second function calls in the second computer code; and update the mapping of the first test case to the function call with the second test case, the second test case comprising a second set of testing scenarios different from the first set of testing scenarios.

### BRIEF DESCRIPTION OF THE DRAWINGS

FIG. 1 is a schematic diagram of a continuous integration and delivery system that includes a test suite engine in accordance with embodiments of the present disclosure.

FIG. 2 is a process flow diagram of an example continuous integration model in accordance with embodiments of the present disclosure.

FIG. 3 is a process flow diagram illustrating probes of subfunctions within code checked into a repository in accordance with embodiments of the present disclosure.

FIGS. 4A-B are process flow diagrams of example mapping of subfunctions to test cases using a test suite engine in accordance with embodiments of the present disclosure.

### DETAILED DESCRIPTION

Aspects of the embodiments of the present disclosure are directed to a continuous integration scheme that uses a test suite engine to identify, store, and execute test cases as needed. In agile environments for enterprise applications, every piece of code a developer commits triggers a build cycle and post build we run integration tests which is time consuming and does not necessarily required for the checked in changes. Most of the time in development developers writes new modules which might or might not be dependent on existing modules. This disclosure describes a continuous automation suite which will run when and what is needed, which will help to fasten the software development process and improve development efficiency.

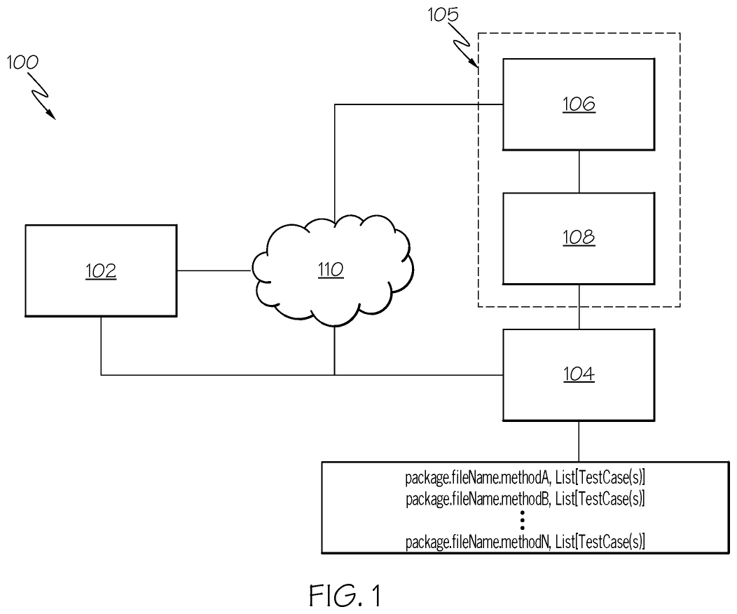

FIG. 1 is a schematic diagram of a continuous integration and delivery system 100 that includes a test suite engine in accordance with embodiments of the present disclosure. System 100 includes a user device 102. User device 102 can be or include a display and one or more input/output devices for writing code, checking code into a continuous automation repository, and interfacing with a continuous automation environment to build, test, and publish code. The user device 102 can include one or more hardware processors, memory for storing data, and a network interface for interfacing with networked components, such as other repositories, cloud-based processors, workstations, servers, etc. The user device 102 can communicate across a network 110 with a repository 104 and/or with networked resources. The repository 104 can be a networked repository or a local repository. The repository 104 can store test case mappings to different functions or methods that the integration engine 106 identifies from uploaded code.

The system 100 can include a test suite engine 105. The test suite engine 105 can include an integration engine 106 and a rule engine 108. The integration engine 106 can be implemented in hardware, software, or a combination of hardware and software housed on a server or mainframe accessible to each developer using the continuous integration system 100. The integration engine 106 can execute a set of test scripts in the continuous deployment pipeline. The integration engine 106 can perform software integration testing of uploaded software. Integration testing can include testing one or more functions or methods within software against various testing scenarios. Said testing scenarios can be part of a test suite that is created for specific functions or methods. The integration engine 106 can perform a full integration test for new software code uploaded to the integration engine 106. The integration engine 106 can map test cases to the function(s) or method(s) introduced by the coding. Each new test case is executed by the integration engine 106 the first time a function or method is evaluated to create a mapping against the function or method. The integration engine 106 can make use of an automation suite to ensure quality.

The continuous integration system 100 can also include a rule engine 108. The rule engine 108 can be implemented in hardware, software, or a combination of hardware or software. The rule engine 108 can specify, for a test suite, the cases or suites that need to be run for the changed or newly added function(s) or method(s) in the uploaded code. Rule engine 108 can have all mappings stored in a database in repository 104 which can be called with each check-in to create the test suite.

The integration engine 106 can be used to perform an initial full integration of uploaded code to identify (sub)functions or methods within the uploaded code for testing. The integration engine 106 can make use of probes within the uploaded code to identify the subfunctions or methods within the uploaded code. The integration engine 106 can perform a full integration test at the outset to create and/or identify test suites for each subfunction or method in the uploaded code. The rule engine 108 can identify cases or existing test suites for each subfunction or method identified by the integration engine 106. The rule engine 108 can associate subfunctions or methods in the uploaded code with created or identified test suites, and store said associations in repository 104.

The rule engine 108 can determine the test suite automatically based on the checked in files. For subsequent file check-ins after an initial integration test, rather than running the complete suites, the rule engine 108 can identify test suites specific for the functions or methods within the checked in code file. Running only a subset of test cases for each function within a checked in code file can improve development and build efficiency and help in today's agile world to have faster development cycle.

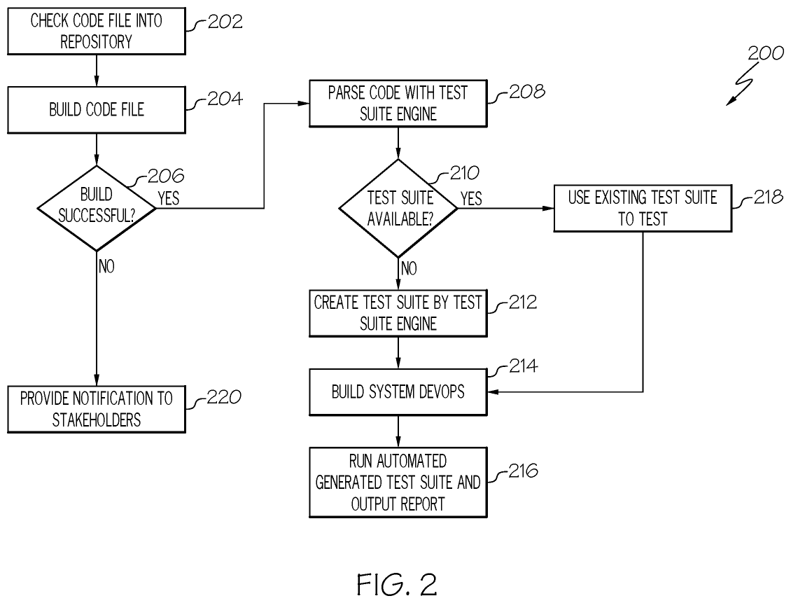

FIG. 2 is a process flow diagram 200 of an example continuous integration model in accordance with embodiments of the present disclosure. At the outset, code is checked into a continuous integration system repository, such as repository 104 described above (202). The code file can be built by a build tool of the CI system (204). The build of the code can verify that the code is ready for testing. If the build is unsuccessful (206), then the CI system can inform the stakeholders in a report (220). If the build is successful (206), then the integration engine can parse the code as part of an initial integration testing on the uploaded code (208). For example, the integration engine can identify one or more functions or methods in the code based on probes within the code that point to the functions or subfunctions. The integration engine (e.g., using a rule engine or other testing engine) can determine whether one or more test suites exist in a repository for each of the functions or methods in the code (210). If a test suite is available, then the integration engine can use the existing test suite to test the function or method as part of the integration testing (218). The system developer operations (devops) can be built to execute the test suite against the code (214). The code can then be tested against the test suite(s) (216).

If the integration engine does not find existing test suites for one or more of the functions or methods in the uploaded code, then the integration engine can map test suites by identifying one or more test cases for the functions or methods in the code (212). For example, during initial uploading of code, a full integration test is performed to perform an initial mapping of test suites (and corresponding test cases) to functions or methods within the code. As another example, a new mapping can be created when changes are made to previously identified functions or methods in code. In another example, a first piece of code can use functions A, B, and C, while another piece of code can use functions A, B, and D. A new test suite can be mapped for function A that includes two test suites: one that tests function A in the context of all functions A, B, and C; and one that tests function A in the context of all functions A, B, and D.

The test suite engine can map existing test cases based on the method call within the uploaded code file. An automation suite can provide existing test cases. If there is no test suite identified, then test suite engine can create test suite from the existing integration test cases already available.

In each of the scenarios above, the integration engine can map test suites to functions or methods within the code, and store said mappings into a repository for use in subsequent testing of code during the continuous integration process. Similar to above, after the test suite is mapped to the functions or methods in the code, the system devops can be built (214), and the integration test can be performed using the mapped test suites (216). The system can generate reports for stakeholders based on the outcome of the integration testing.

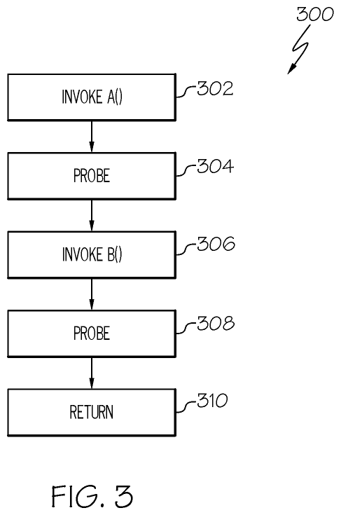

FIG. 3 is a block diagram 300 illustrating probes of subfunctions within code checked into a repository in accordance with embodiments of the present disclosure. Diagram 300 illustrates a simplified block diagram of uploaded code. The code includes two functions: invoke a( ) 302 and invoke b( ) 306. After the invoke a( ) function, a probe 304 can be included to allow the integration engine to identify invoke a( ) 302 as a function that is to be integration tested by the integration engine. Likewise, probe 308 can be included to allow the integration engine to identify invoke b( ) 306 as a function that is to be integration tested by the integration engine. The end of the code can include a return call 308.

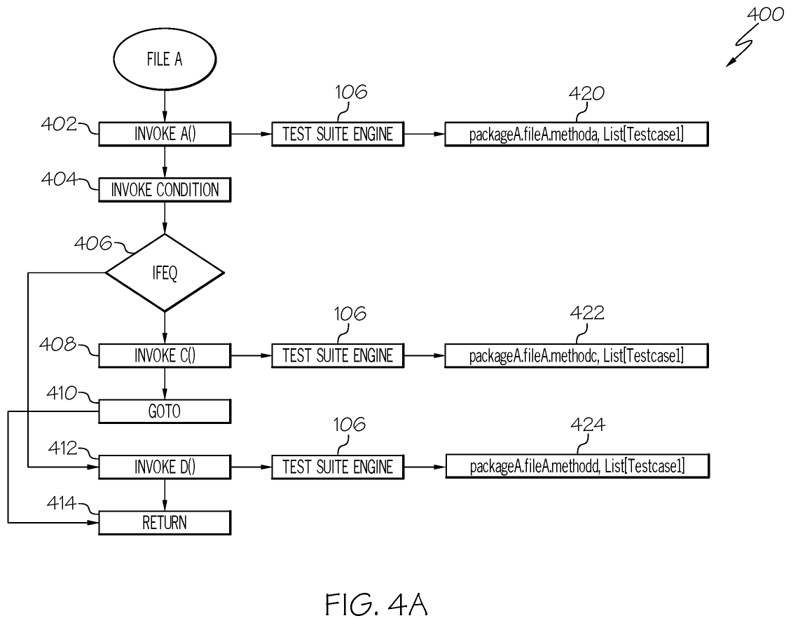

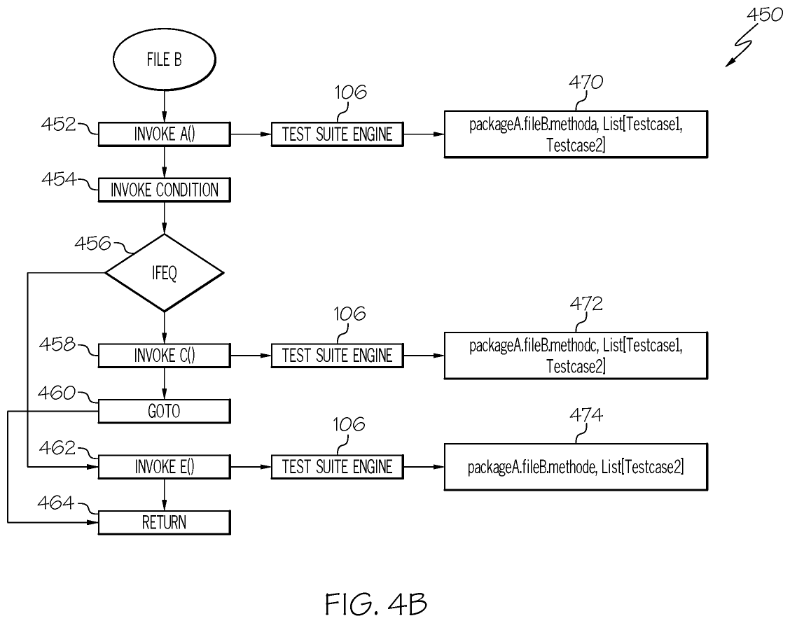

FIGS. 4A-B are process flow diagrams of example mapping of subfunctions to test cases using a test suite engine in accordance with embodiments of the present disclosure. FIG. 4A illustrates how each function in code file A 400 is mapped to a test suite. The code file A can include an invoke a( ) function 402 followed by the invocation of the condition for a( ) (404). The example code can include a conditional statement 406 that calls either invoke c( ) 408 or invoke d( ) 412. The invoke c( ) can include a goto command 410. The end of the code file A 400 can then return 414. The functions 402, 408, and 412 can also include probes that the integration engine can use to identify the various functions in the code file.

At the initial check in of code file A 400, the test suite engine 105 can perform a full integration test of the code file A and the functions or methods therein. The test suite engine 105 can use a rule engine 108 to map test cases to one or more functions in code file A. (Collectively, one or more test cases can be referred to as a test suite.) As an example, the test suite engine 105 can map function invoke a( ) 402 to a Testcase1. The mapping 420 can include a unique identifier of the function: packageA.fileA.methoda; and a test suite: List[Testcase1]. The test suite can include a listing of test cases, as described in FIG. 4B.

The integration engine can also map function invoke c( ) 408 to Testcase1. The mapping 422 can include a unique identifier of the function: packageA.fileA.methodc; and a test suite: List[Testcase1]. The integration engine can also map function invoke d( ) 412 to Testcase1. The mapping 424 can include a unique identifier of the function: packageA.fileA.methodd; and a test suite: List[Testcase1]. The mappings can be stored in a repository (such as repository 104) that is accessible by the test suite engine 105.

In subsequent integration tests, the integration engine can use the associated test suites to perform integration testing on the checked in code file (or more specifically, on the functions within the checked in code file), as opposed to performing a full integration test. Once a build is successful, the integration engine can use predefined test cases mapped to the code file or to the functions associated therewith, which saves time on the integration testing.

FIG. 4B illustrates a code file B 450 that can be checked into a CI repository for integration testing. The code file B 450 includes an invoke a( ) function 452 followed by the invocation of the condition for a( ) (454). The example code can include a conditional statement 456 that calls either invoke c( ) 458 or invoke e( ) 462. The invoke c( ) can include a goto command 460. The end of the code file B 450 can then return 464. The functions 452, 458, and 462 can also include probes that the integration engine can use to identify the various functions in the code file.

Notably, code file B 450 includes two of the same functions as were in code file A: invoke a( ) and invoke c( ). The code file B 450 also includes an invoke e( ) function 462 that is not present in code file A 400. The test suite engine 105 (e.g., using a rule engine 108) can map invoke a( ) 452 to a second set of test cases. The mapping can list the test cases with a unique identifier for the function: packageA.fileB.methoda, List[Testcase1, Testcase2]. The test case list is augmented with a second set of test cases because function invoke a( ) 452 is now being used in a code file that includes an additional function (invoke e( ). The test suite engine 105 (e.g., using a rule engine 108) can map invoke c( ) 458 to a second set of test cases. The mapping can list the test cases with a unique identifier for the function: packageA.fileB.methodc, List[Testcase1, Testcase2]. The test case list is augmented with a second set of test cases because function invoke c( ) 458 is now being used in a code file that includes an additional function (invoke e( ). The test suite engine 105 (e.g., using a rule engine 108) can map invoke e( ) 462 to a set of test cases. The mapping can list the test cases with a unique identifier for the function: packageA.fileB.methode, List[Testcase2]. Invoke e( ) 462 is only mapped to testcase 2 in this example because the integration engine has not established any other test suites for invoke e( ) 462 from prior integration tests. The mappings can be stored in the repository 104.

In subsequent uploads of code file A 400, the functions invoke a( ) and invoke b( ) can be tested using the test suite: [Testcase1, Testcase2].

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the disclosure. Other embodiments will be apparent to those of ordinary skill in the art from a consideration of the specification or practice of the disclosure disclosed herein. It will also be understood by those of ordinary skill in the art that the scope of the disclosure is not limited to use in a server diagnostic context, but rather that embodiments of the disclosure may be used in any transaction having a need to monitor information of any type. The specification and the described examples are considered as exemplary only, with the true scope and spirit of the disclosure indicated by the following claims.

As indicated above, the network entities that make up the network that is being managed by the network management system are represented by software models in the virtual network machine. The models represent network devices such as printed circuit boards, printed circuit board racks, bridges, routers, hubs, cables and the like. The models also represent locations or topologies. Location models represent the parts of a network geographically associated with a building, country, floor, panel, rack, region, room, section, sector, site, or the world. Topological models represent the network devices that are topologically associated with a local area network or subnetwork. Models can also represent components of network devices such as individual printed circuit boards, ports and the like. In addition, models can represent software applications such as data relay, network monitor, terminal server and end point operations. In general, models can represent any network entity that is of interest in connection with managing or monitoring the network.

The virtual network machine includes a collection of models which represent the various network entities. The models themselves are collections of C++ objects. The virtual network machine also includes model relations which define the interrelationships between the various models. Several types of relations can be specified. A “connects to” relation is used to specify an interconnection between network devices. For example, the interconnection between two workstations is specified by a “connects to” relation. A “contains” relation is used to specify a network entity that is contained within another network entity. Thus for example, a workstation model may be contained in a room, building or local network model. An “executes” relation is used to specify the relation between a software application and the network device on which it runs. An “is part of” relation specifies the relation between a network device and its components. For example, a port model may be part of a board model or a card rack model.

What is claimed is:

1. A non-transitory computer-readable medium having program instructions stored therein, wherein the program instructions are executable by a computer system to perform operations comprising:
identifying, by a test suite engine of a continuous integration system, a function call in computer code;
identifying, from an identifier of the function call, a test suite to test the function call, the test suite comprising a subset of test cases corresponding to the function call;
testing the computer code using subset of test cases comprised in the test suite; and
providing a report identifying a result of the testing of the computer code.

2. The non-transitory computer-readable medium of claim 1, wherein the computer code comprises a plurality of function calls, the operations further comprising:
identifying, from an identifier of each of the plurality of function calls, a test case mapped to each of the plurality of function calls; and
testing the computer code using the test case mapped to each of the plurality of function calls.

3. The non-transitory computer-readable medium of claim 1, the operations further comprising:
performing an integration test on the computer code;
identifying the function call from the full integration test;
determining one or more testing scenarios used in the integration test to test the function call;
mapping the one or more testing scenarios to a test case;
mapping the test case to the function call based on the identifier of the function call; and
storing the test case in a repository.

4. The non-transitory computer-readable medium of claim 3, wherein identifying, by the testing engine, the function call in the computer code comprises identifying the function call using a probe function.

5. The non-transitory computer-readable medium of claim 1, wherein identifying, from an identifier of the function call, a test case mapped to the function call, the test case comprising one or more testing scenarios to test the function call comprises:
determining that a test case associated with the identifier of the function call does not exist;
performing a integration test on the function call, the integration test comprising:
testing the function call using one or more testing scenarios,
mapping the testing scenarios to a new test case,
associating the new test case with the identifier of the function call, and
storing the test case in a repository; and
using the new test case to test the function call using the one or more mapped testing scenarios.

6. The non-transitory computer-readable medium of claim 1, wherein test case is mapped to an identifier of the function call using a format that comprises the identifier of the function call and a list of the one or more testing scenarios.

7. The non-transitory computer-readable medium of claim 1, wherein:
the function call is a first function call;
the computer code is a first computer code;
the one or more testing scenarios is a first set of testing scenarios; and
the test case is a first test case;
the operations further comprising:
identifying the first function call in a second computer code, the second computer code comprising a plurality of second function calls;
identifying a second test case for the first function call based on one or more test cases identified for the plurality of second function calls in the second computer code; and
updating the mapping of the first test case to the function call with the second test case, the second test case comprising a second set of testing scenarios different from the first set of testing scenarios.

8. A computer-implemented method comprising:
identifying, by a testing engine, a function call in computer code;
identifying, from an identifier of the function call, a test case mapped to the function call, the test case comprising one or more testing scenarios to test the function call;
testing the computer code using the test case; and
providing a report identifying a result of the testing of the computer code.

9. The computer-implemented method of claim 8, the method further comprising:
identifying, from an identifier of each of the plurality of function calls, a test case mapped to each of the plurality of function calls; and
testing the computer code using the test case mapped to each of the plurality of function calls.

10. The computer-implemented method of claim 8, the method further comprising:
performing an integration test on the computer code;
identifying the function call from the full integration test;
determining one or more testing scenarios used in the integration test to test the function call;
mapping the one or more testing scenarios to a test case;
mapping the test case to the function call based on the identifier of the function call; and
storing the test case in a repository.

11. The computer-implemented method of claim 10, wherein identifying, by the testing engine, the function call in the computer code comprises identifying the function call using a probe function.

12. The computer-implemented method of claim 8, wherein identifying, from an identifier of the function call, a test case mapped to the function call, the test case comprising one or more testing scenarios to test the function call comprises:
determining that a test case associated with the identifier of the function call does not exist;
performing a integration test on the function call, the integration test comprising:
testing the function call using one or more testing scenarios,
mapping the testing scenarios to a new test case,
associating the new test case with the identifier of the function call, and
storing the test case in a repository; and
using the new test case to test the function call using the one or more mapped testing scenarios.

13. The computer-implemented method of claim 8, wherein test case is mapped to an identifier of the function call using a format that comprises the identifier of the function call and a list of the one or more testing scenarios.

14. The computer-implemented method of claim 8, wherein:
the function call is a first function call;
the computer code is a first computer code;
the one or more testing scenarios is a first set of testing scenarios; and
the test case is a first test case;
the method further comprising:
identifying the first function call in a second computer code, the second computer code comprising a plurality of second function calls;
identifying a second test case for the first function call based on one or more test cases identified for the plurality of second function calls in the second computer code; and
updating the mapping of the first test case to the function call with the second test case, the second test case comprising a second set of testing scenarios different from the first set of testing scenarios.

15. A system comprising:
a hardware processor; and
a memory communicably coupled to the hardware processor, the memory for storing data;
the hardware processor to:
identify, by a testing engine, a function call in computer code;
identify, from an identifier of the function call, a test case stored in the memory and mapped to the function call, the test case comprising one or more testing scenarios to test the function call;
test the computer code using the test case; and
provide a report identifying a result of the testing of the computer code.

16. The system of claim 15, wherein the memory comprises a remote storage accessible by the hardware processor across a network.

17. The system of claim 15, the hardware processor to:
identify, from an identifier of each of the plurality of function calls, a test case mapped to each of the plurality of function calls; and
test the computer code using the test case mapped to each of the plurality of function calls.

18. The system of claim 15, the hardware processor to:
perform an integration test on the computer code;
identify the function call from the full integration test;
determine one or more testing scenarios used in the integration test to test the function call;
map the one or more testing scenarios to a test case;
map the test case to the function call based on the identifier of the function call; and
store the test case in a repository.

19. The system of claim 18, wherein identifying, by the testing engine, the function call in the computer code comprises identifying the function call using a probe function.

20. The system of claim 15, wherein the hardware processor to:
determine that a test case associated with the identifier of the function call does not exist;
perform a integration test on the function call, the integration test comprising:
testing the function call using one or more testing scenarios,
mapping the testing scenarios to a new test case,
associating the new test case with the identifier of the function call, and
storing the test case in a repository; and
use the new test case to test the function call using the one or more mapped testing scenarios.

21. The system of claim 15, wherein the hardware processor maps the test case mapped to an identifier of the function call using a format that comprises the identifier of the function call and a list of the one or more testing scenarios.

22. The system of claim 15, wherein:
the function call is a first function call;
the computer code is a first computer code;
the one or more testing scenarios is a first set of testing scenarios; and
the test case is a first test case;
the hardware processor to:
identify the first function call in a second computer code, the second computer code comprising a plurality of second function calls;
identify a second test case for the first function call based on one or more test cases identified for the plurality of second function calls in the second computer code; and
update the mapping of the first test case to the function call with the second test case, the second test case comprising a second set of testing scenarios different from the first set of testing scenarios.
